(19) United States
(12) Patent Application Publication
(10) Pub. No.: US 2009/0016243 A1
(43) Pub. Date: Jan. 15, 2009

(54) WIRELESS COMMUNICATION DEVICE, WIRELESS COMMUNICATION SYSTEM, AND WIRELESS COMMUNICATION METHOD

(75) Inventors: Shigeru Kimura, Yokohama (JP); Fangwei Tong, Yokohama (JP)

Correspondence Address: DITTHAVONG MORI & STEINER, P.C., 918 Prince St., Alexandria, VA, 22314, US

(73) Assignee: KYOCERA Corporation, Kyoto (JP)

(21) Appl. No.: 11/909,769

(22) PCT Filed: Mar. 29, 2006
(86) PCT No.: PCT/JP2006/306535

§ 371 Date: Sep. 26, 2007

(30) Foreign Application Priority Data
Mar. 30, 2005 (JP) 2005-098519

(51) Int. Cl. H04J 3/00

(52) U.S. Cl. 370/280

(57) ABSTRACT

A wireless communication device for transmitting/receiving data uses a plurality of carrier frequencies in a time division duplex scheme. The wireless communication device includes a scheduler for selecting a slot of at least one carrier frequency for transmission of the data; and transmission data assignment means for assigning the data to the slot of the carrier frequency selected by the scheduler and making a slot of a carrier frequency not selected by the scheduler empty.

### TECHNICAL FIELD

The present invention relates to wireless communication devices, wireless communication systems, and wireless communication methods.

The present application claims priority from Japanese Patent Application No. 2005-98519 filed on Mar. 30, 2005, the entire contents of which are incorporated herein by reference.

### BACKGROUND ART

In a SDMA (Spatial Division Multiple Access) wireless communication system, a base station has an adaptive array antenna. In the case where a plurality of user terminals serving as mobile stations (hereinafter referred to as terminals) exist, the base station forms a transmission beam having a radiation pattern whose directivity is different according to the terminals and simultaneously transmits radio waves to a plurality of terminals. When forming a radiation pattern for a certain terminal among the plurality of terminals, the base station forms a transmission beam directed to the terminal serving as a transmission partner using the adaptive array antenna and forms null directed to the remaining terminals. Accordingly, the base station assigns the same frequency channel to the terminals at the same time, thereby increasing the channel utilization efficiency.

In the above-described SDMA wireless communication system, the characteristics of a wireless-signal propagation path between the base station and each terminal must be estimated so that the base station can form a radiation pattern of a transmission beam with accurate directivity. Therefore, the SDMA wireless communication system is generally applied to a wireless communication system using the TDD (Time Division Duplex) scheme.

In the TDD scheme, the base station and each terminal perform transmission or reception using the same frequency and perform transmission or reception in different time slots (or simply referred to as slots). Since the same frequency is used in the TDD scheme, the base station estimates the characteristics of a wireless-signal propagation path between the base station and the terminal on the basis of a signal received at a reception slot. The estimated characteristics of the wireless-signal propagation path make the directivity for transmission more accurate, thereby realizing the SDMA wireless communication system (e.g., see Patent Document 1).

### Patent Document 1: Japanese Unexamined Patent Application Publication No. 2004-356993

### DISCLOSURE OF INVENTION

### Problems to be Solved by the Invention

However, the above-described known TDD/SDMA wireless communication system assumes the use of only one carrier frequency. Therefore, in the case where a plurality of carrier frequencies is used, the following problems occur.

That is, in the case where one carrier frequency is fixedly used for transmission of uplink signals from each terminal to a base station in a wireless communication system using a plurality of carrier frequencies (for example, in the case of almost no uplink signals from the terminal to the base station, as in the case where the terminal downloads contents, and only one carrier frequency is necessary for uplink transmission), the base station can obtain reception information only regarding the carrier frequency used for transmission of uplink signals from the terminal, and cannot obtain reception information regarding the other carrier frequency (frequencies). Therefore, the base station cannot estimate the characteristics of a wireless-signal propagation path between the base station and the terminal, and cannot form a radiation pattern of the adaptive array antenna to have proper directivity.

Another problem occurs in the above-described wireless communication system using a plurality of carrier frequencies in the case where, for example, transmission of uplink signals is performed from each terminal to the base station by simultaneously selecting two carrier frequencies at random, and the same terminal may simultaneously transmit uplink signals to the base station using the two carrier frequencies. In such a case, the terminal requires transmission power for the two carrier frequencies, and hence a transmission circuit needs to be augmented, resulting in an increase in the cost. If the transmission power of the terminal is limited, the limitation may not be enforceable.

In view of the foregoing circumstances, it is an object of the present invention to provide, in a wireless communication system for transmitting/receiving data using the TDD scheme between terminals and a base station using a plurality of carrier frequencies, a wireless communication device capable of properly using the carrier frequencies, the wireless communication system, and a wireless communication method.

### Means for Solving the Problems

In order to solve the above-described problems, a wireless communication device according to the present invention is a wireless communication device for transmitting/receiving data using a plurality of carrier frequencies in a time division duplex scheme, including the following elements: a scheduler for selecting a slot of at least one carrier frequency for transmission of the data; and transmission data assignment means for assigning the data to the slot of the carrier frequency selected by the scheduler and making a slot of a carrier frequency not selected by the scheduler empty.

In the wireless communication device, it is preferable that the scheduler control, for data transmission in a next frame, carrier frequency selection so as to select a slot of a carrier frequency not selected for data transmission in an immediately preceding frame.

Further, a wireless communication device according to the present invention is a wireless communication device for transmitting/receiving data using a plurality of carrier frequencies in a time division duplex scheme, including the following elements: a scheduler for selecting a slot of at least one carrier frequency for transmission of the data; and transmission data assignment means for assigning the data to the slot of the carrier frequency selected by the scheduler. The scheduler selects slots of the plurality of carrier frequencies in the case where transmission power is within a limit range.

A wireless communication system according to the present invention includes a mobile station device including the above-described wireless communication device and an adaptive-array base-station device for establishing wireless link with the mobile station device.

A wireless communication method according to the present invention is a wireless communication method for transmitting/receiving data by a first wireless communication device to/from a second wireless communication device using a plurality of carrier frequencies in a time division duplex scheme, including the following steps: a first step of selecting a slot of at least one carrier frequency for transmission of the data; a second step of assigning the data to the slot of the carrier frequency selected in the first step and making a slot of a carrier frequency not selected in the first step empty; and a third step of controlling, for data transmission in a next frame, carrier selection so as to select a slot of a carrier frequency not selected in the first step.

Further, a wireless communication method according to the present invention is a wireless communication method for transmitting/receiving data by a first wireless communication device to/from a second wireless communication device using a plurality of carrier frequencies in a time division duplex scheme, including the following steps: a first step of selecting a slot of at least one carrier frequency for transmission of the data; and a second step of assigning the data to the slot of the carrier frequency selected in the first step. In the first step, slots of the plurality of carrier frequencies are selected in the case where transmission power is within a limit range.

### ADVANTAGES

According to the present invention, carrier frequencies can be properly used by a wireless communication device for transmitting/receiving data using a plurality of carrier frequencies in the TDD scheme.

### BRIEF DESCRIPTION OF THE DRAWINGS

FIG. 1 is a block diagram of the structure of a wireless communication device according to an embodiment of the present invention.

FIG. 2 illustrates an exemplary frame structure in the TDMA/TDD (Time Division Multiple Access/Time Division Duplex) scheme.

FIG. 3 illustrates exemplary carrier selection according to the embodiment of the present invention.

FIG. 4 is a block diagram of the structure of a transmission data assembling unit illustrated in FIG. 1.

FIG. 5 is a flowchart of a first process performed by a scheduler illustrated in FIG. 1.

FIG. 6 is a flowchart of a second process performed by the scheduler illustrated in FIG. 1.

FIG. 7 is a flowchart of a third process performed by the scheduler illustrated in FIG. 1.

### REFERENCE NUMERALS

2: antenna
4: duplexer
10: transmission data assembling unit
12: modulation unit
14: up converter
16: scheduler
22: buffers
24: counters
26: data assignment unit

### BEST MODE FOR CARRYING OUT THE INVENTION

An embodiment of the present invention will be described hereinafter with reference to the drawings.

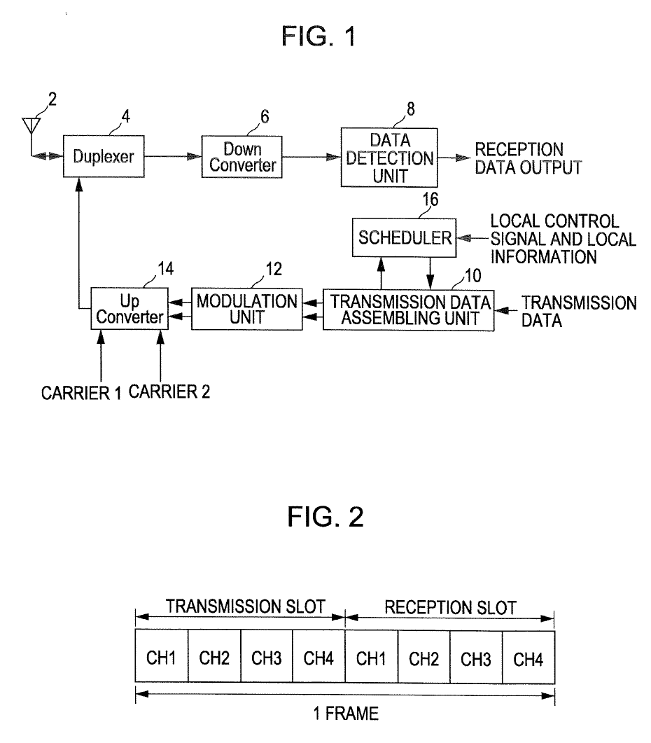

FIG. 1 is a block diagram of the structure of a wireless communication device according to an embodiment of the present invention. The wireless communication device illustrated in FIG. 1 (first wireless communication device) uses a plurality of carrier frequencies to transmit/receive data to/from another wireless communication device (second wireless communication device) using the TDD (Time Division Duplex) scheme. Further, the wireless communication device can transmit/receive data to/from the other wireless communication device using the TDD/SDMA (Time Division Duplex/Spatial Division Multiple Access) scheme. The wireless communication device can be used as, for example, a wireless terminal device serving as a mobile station.

Referring to FIG. 1, a wireless signal received at an antenna 2 is input via a duplexer 4 to a down converter 6 and is converted into a baseband signal, which is thereafter input to a data detection unit 8. The data detection unit 8 detects reception data according to the signal input thereto.

For transmission of transmission data, the transmission data is input to a transmission data assembling unit 10 and is packeted into, for example, a transmission slot in a frame illustrated in FIG. 2. Each carrier frequency has its own frame. The transmission data assembling unit 10 selects a frame of a carrier frequency specified by a scheduler 16 and packets the transmission data into a transmission slot in the frame. A transmission signal packeted by the transmission data assembling unit 10 into the transmission slot in the frame is input to a modulation unit 12 and is modulated, and the modulated signal is input to an up converter 14 and is converted into a radio signal for a predetermined carrier frequency (1 or 2). The radio signal is transmitted via the duplexer 4 from the antenna 2.

The scheduler 16 selects a time slot of a carrier frequency from among a plurality of carrier frequencies on the basis of information such as carrier frequency utilization history (information regarding the carrier usage frequency of each carrier frequency) sent from the transmission data assembling unit 10 and a local control signal and local information that were sent from a local, and informs the transmission data assembling unit 10 of the selection result. In the case where the total transmission power of the wireless communication device required for a plurality of carrier frequencies is within a limit range, the scheduler 16 is controlled to select time slots of the plurality of carrier frequencies.

For the sake of convenience of the description, a system using two carrier frequencies 1 and 2 will be described by way of example. However, the present invention is similarly applicable to the case of using three or more carrier frequencies.

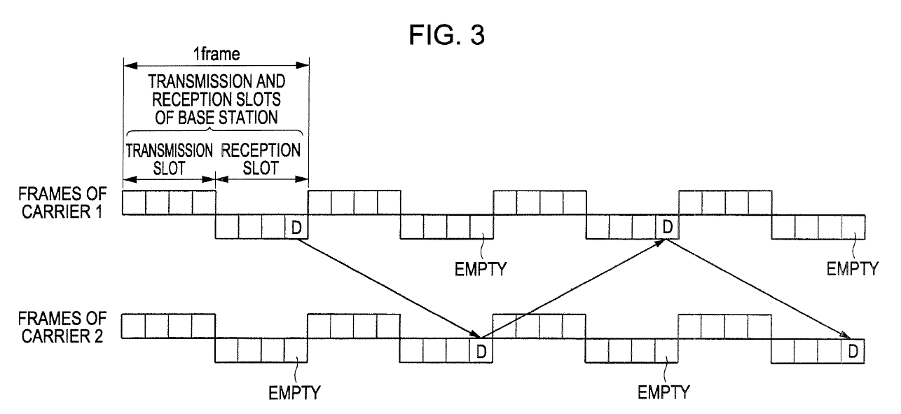

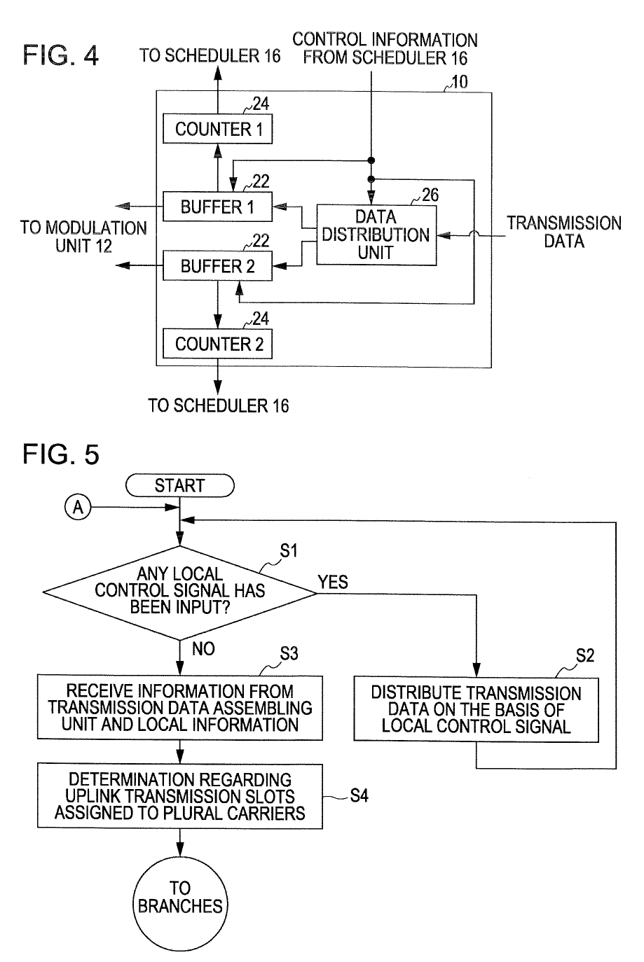

FIG. 3 illustrates exemplary carrier frequency selection according to the embodiment.

An upper portion of FIG. 3 illustrates an example of how frames are used in carrier frequency 1, and a lower portion of FIG. 3 illustrates an example of how frames are used in carrier frequency 2. These examples of how frames are used in FIG. 3 are examples of how frames are used from a base station (second wireless communication device) view. Transmission slots in the illustration are for downlink signals from the base station to each terminal, and reception slots in the illustration are for uplink signals from each terminal to the base station. The frame structure is illustrated in FIG. 2. An example of how frames are used from a mobile station view will be such that the reception slots illustrated in FIGS. 2 and 3 become transmission slots, and the transmission slots illustrated in FIGS. 2 and 3 become reception slots.

Referring to FIG. 3, carrier frequency 1 is selected by the scheduler 16 in the first frame, and data D is packeted into time slot CH4 in a reception slot. In this case, time slot CH4 in a reception slot of carrier frequency 2, which has not been selected by the scheduler 16, is an empty slot. That is, during data transmission using one carrier frequency selected by the scheduler 16, no data is transmitted using the other carrier frequency, which is not selected by the scheduler 16.

In the second frame, carrier frequency 2, which was not selected by the scheduler 16 in the previous frame, is selected by the scheduler 16, and data D is unit 26 and assembles a transmission slot. In this case, the buffer 22 informs the counter 24 corresponding thereto of a slot number (CH1, CH2, CH3, or CH4) in the transmission slot currently being assembled and information indicating whether the transmission data is currently being packeted or not.

In response to an instruction from the scheduler 16, the buffer 22 may hold the transmission data received from the data assignment unit 26 without packetting it into the transmission slot currently being assembled. For example, the buffer 22 holds the transmission data until a transmission slot of the next frame is assembled.

The counter 24 informs the scheduler 16 of the slot number and the information indicating whether the transmission data is currently being packeted or not, which have been sent from the buffer 22. Further, the counter 24 counts the number of slots used for data transmission by the wireless communication device using a carrier frequency corresponding thereto. The scheduler 16 is also informed of the count result. Accordingly, the scheduler 16 is informed of, for each carrier frequency, the slot number used for data transmission by the wireless communication device using the transmission slot currently being assembled (usage of the transmission slot currently being assembled according to each carrier frequency) and the number of slots that have been used so far for data transmission by the wireless communication device.

In accordance with an instruction from the scheduler 16, the data assignment unit 26 selectively transmits the transmission data to either the buffer 1_22 for carrier frequency 1 or the buffer 2_22 for carrier frequency 2.

The buffer 1_22 and the buffer 2_22, which are provided for carrier frequencies 1 and 2, respectively, output transmission signals assembled by the transmission data assembling unit 10 to the modulation unit 12. The buffer 1_22 and the buffer 2_22 may output the transmission signals to the modulation unit 12 after all the transmission slots have been completely assembled. Alternatively, the buffer 1_22 and the buffer 2_22 may output the transmission signals to the modulation unit 12 upon completion of assembly of each time slot.

The modulation unit 12 modulates the transmission signals for the respective carrier frequencies from the buffer 1_22 and the buffer 2_22 and outputs the modulated signals to the up converter 14.

Referring now to FIGS. 5, 6, and 7, the operation of the scheduler 16 is described. FIGS. 5, 6, and 7 show the processing flow of the scheduler 16.

Referring to FIG. 5, the scheduler 16 determines whether a local control signal has been input thereto (step S1). In the case where a local control signal has been input to the scheduler 16, the scheduler 16 determines to distribute transmission data among a plurality of carrier frequencies on the basis of the local control signal (step S2). The local control signal is, for example, a signal used when a user switches a carrier frequency.

In contrast, in the case where no local control signal has been input to the scheduler 16, the scheduler 16 receives information from the transmission data assembling unit 10 and from the local (step S3). On the basis of the information received, the scheduler 16 determines which step should be the next step (step S4).

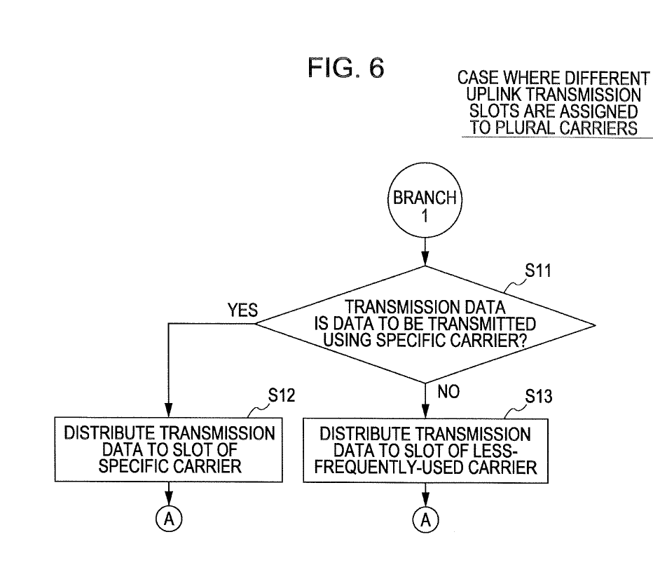

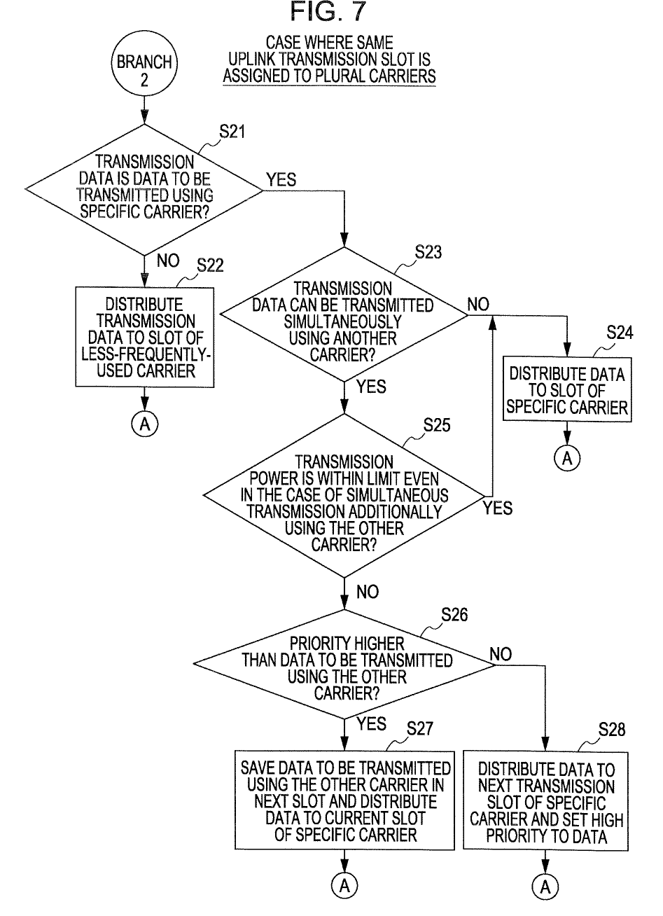

In the case where it is determined in step S4 that different slot numbers are assigned to a plurality of carrier frequencies, the scheduler 16 selects branch 1 and proceeds to step S11 in FIG. 6. In contrast, in the case where the same slot number is assigned to the plurality of carrier frequencies, the scheduler 16 selects branch 2 and proceeds to step S21 in FIG. 7.

Referring now to FIG. 6, the scheduler 16 determines whether transmission data to be distributed by the data assignment unit 26 of the transmission data assembling unit 10 is data to be transmitted using a specific carrier frequency on the basis of local information (step S11). In the case where the determination result shows that the transmission data to be distributed by the data assignment unit 26 of the transmission data assembling unit 10 is transmission data to be transmitted using a specific carrier frequency, the scheduler 16 instructs the transmission data assembling unit 10 to distribute the transmission data to a time slot assigned to the specific carrier frequency (step S12). Thereafter, the flow returns to step S1 in FIG. 5.

In contrast, in the case where the determination result shows that the transmission data to be distributed by the data assignment unit 26 of the transmission data assembling unit 10 is not transmission data to be transmitted using a specific carrier frequency, the scheduler 16 instructs the transmission data assembling unit 10 to distribute the transmission data to a time slot assigned to a less-frequently-used carrier frequency (step S13). Thereafter, the flow returns to step S1 in FIG. 5. The frequency of using each is based on the number of slots used according to each carrier frequency, which is counted by the counter 24 and reported from the transmission data assembling unit 10.

Referring now to FIG. 7, the scheduler 16 determines whether the transmission data to be distributed by the data assignment unit 26 of the transmission data assembling unit 10 is data to be transmitted using a specific carrier frequency (step S21). In the case where the determination result shows that the transmission data to be distributed by the data assignment unit 26 of the transmission data assembling unit 10 is not transmission data to be transmitted using a specific carrier frequency, the scheduler 16 instructs the transmission data assembling unit 10 to distribute the transmission data to a time slot assigned to a less-frequently-used carrier frequency (step S22). Thereafter, the flow returns to step S1 in FIG. 5. In contrast, in the case where the determination result shows that the transmission data to be distributed by the data assignment unit 26 of the transmission data assembling unit 10 is transmission data to be transmitted using a specific carrier frequency, the scheduler 16 determines whether to transmit the transmission data simultaneously using another carrier frequency besides the specific carrier frequency (step S23). In this case, the scheduler 16 performs the determination on the basis of information indicating the usage of a transmission slot currently being assembled for each carrier frequency, which has been input from the transmission data assembling unit 10.

In the case where the determination result in step S23 shows that the transmission data is not to be transmitted simultaneously using the specific carrier frequency and the other carrier frequency, the scheduler 16 instructs the transmission data assembling unit 10 to distribute the transmission data to a time slot assigned to the specific carrier frequency (step S24). Thereafter, the flow returns to step S1 in FIG. 5. In contrast, in the case where the determination in step S23 shows that the transmission data can be transmitted simultaneously using the specific carrier frequency and the other carrier frequency, the scheduler 16 further determines on the basis of local information whether the total transmission power of the wireless communication device required for the carrier frequencies to be transmitted simultaneously is within a limit range (step S25).

In the case where the determination result in step S25 shows that the total transmission power of the wireless communication device required for the carrier frequencies is within the limit range, the scheduler 16 instructs the transmission data assembling unit 10 to distribute the transmission data to a time slot assigned to the specific carrier frequency (step S24). Thereafter, the flow returns to step S1 in FIG. 5.

In contrast, in the case where the determination result in step S25 shows that the total transmission power of the wireless communication device required for the carrier frequencies is not within the limit range, the scheduler 16 compares the transmission priority of pieces of transmission data to be transmitted simultaneously using the respective carrier frequencies and determines whether the priority of the transmission data to be transmitted using the specific carrier frequency is higher than that of data to be transmitted using the other carrier frequency (step S26). In this case, the scheduler 16 performs the determination on the basis of local information. More specifically, the scheduler 16 determines, for example, audio data and response data (ACK, NACK, or the like) to the communication partner as having high priority, and other types of data as having low priority.

In the case where the determination result in step S26 shows that the transmission data to be transmitted using the specific carrier frequency has higher priority, the scheduler 16 instructs the transmission data assembling unit 10 not to packet the data to be transmitted using the other carrier frequency into the time slot currently being assembled and to hold the data. In addition, the scheduler 16 instructs the transmission data assembling unit 10 to distribute the transmission data to a time slot assigned to the specific carrier frequency (step S27). Thereafter, the flow returns to step S1 in FIG. 5. The scheduler 16 sets the highest priority to the held transmission data so as to be certainly transmitted using a transmission slot of the next frame.

In contrast, in the case where the determination result in step S26 shows that the transmission data to be transmitted using the specific carrier frequency has the same or lower priority, the scheduler 16 instructs the transmission data assembling unit 10 not to packet the data to be transmitted using the specific carrier frequency into the time slot currently being assembled and to hold the data. In addition, the scheduler 16 sets the highest transmission priority to the held transmission data so as to be certainly transmitted using a transmission slot of the next frame (step S28). Thereafter, the flow returns to step S1 in FIG. 5.

As has been described above, according to the embodiment, transmission slots of a plurality of carrier frequencies are not simultaneously used for transmission or, in the case where the transmission slots of the plurality of carrier frequencies are simultaneously used for transmission, the total transmission power of the wireless communication device required for the carrier frequencies can be controlled to be within a limit range. Accordingly, the carrier utilization efficiency can be improved while observing the limit of transmission power of the wireless communication device.

Further, the carrier frequencies of using the carrier frequencies can be controlled to be uniform. Accordingly, in, for example, a TDD/SDMA (Time Division Duplex/Spatial Division Multiple Access) wireless communication system, a wireless communication device serving as an adaptive-array base-station device with an adaptive array antenna can obtain reception information uniformly regarding all the carrier frequencies from a wireless communication device serving as a mobile station wireless terminal device according to the above-described embodiment. Therefore, the wireless communication device serving as the adaptive-array base-station device can form a radiation pattern of the adaptive array antenna to have appropriate directivity.

Although the embodiment of the present invention has been described in detail with reference the drawings, the specific structure is not limited thereto, and design changes and the like can be made without departing from the scope of the present invention.

### INDUSTRIAL APPLICABILITY

The present invention can be applied to a wireless communication device and a wireless communication system for transmitting/receiving data using a plurality of carrier frequencies in the TDD scheme and, in the wireless communication system, the carrier frequencies can be properly used.

1. A wireless communication device for transmitting/receiving data using a plurality of carrier frequencies in a time division duplex scheme, comprising:
a scheduler for selecting a slot of at least one carrier frequency for transmission of the data; and
transmission data assignment means for assigning the data to the slot of the carrier frequency selected by the scheduler and making a slot of a carrier frequency not selected by the scheduler empty.

2. The wireless communication device according to claim 1, wherein the scheduler controls, for data transmission in a next frame, carrier selection so as to select a slot of a carrier frequency not selected for data transmission in an immediately preceding frame.

3. A wireless communication device for transmitting/receiving data using a plurality of carrier frequencies in a time division duplex scheme, comprising:
a scheduler for selecting a slot of at least one carrier frequency for transmission of the data; and
transmission data assignment means for assigning the data to the slot of the carrier frequency selected by the scheduler,
wherein the scheduler selects slots of the plurality of carrier frequencies in the case where transmission power is within a limit range.

4. A wireless communication system comprising a mobile station device including a wireless communication device according to claim 1 and an adaptive-array base-station device for establishing wireless link with the mobile station device.

5. A wireless communication method for transmitting/receiving data by a first wireless communication device to/from a second wireless communication device using a plurality of carrier frequencies in a time division duplex scheme, comprising:
a first step of selecting a slot of at least one carrier frequency for transmission of the data;
a second step of assigning the data to the slot of the carrier frequency selected in the first step and making a slot of a carrier frequency not selected in the first step empty; and
a third step of controlling, for data transmission in a next frame, carrier selection so as to select a slot of a carrier frequency not selected in the first step.

6. A wireless communication method for transmitting/receiving data by a first wireless communication device to/from a second wireless communication device using a plurality of carrier frequencies in a time division duplex scheme, comprising:
a first step of selecting a slot of at least one carrier frequency for transmission of the data; and
a second step of assigning the data to the slot of the carrier frequency selected in the first step,
wherein, in the first step, slots of the plurality of carrier frequencies are selected in the case where transmission power is within a limit range.
